(19) United States
(12) Patent Application Publication
(10) Pub. No.: US 2016/0162779 A1
(43) Pub. Date: Jun. 9, 2016

(54) DEVICE, SYSTEM AND METHOD FOR GENERATING A PREDICTIVE MODEL BY MACHINE LEARNING

(71) Applicant: RealMatch, Inc., New York, NY (US)

(72) Inventors: David J. MARCUS, Potomac, MD (US); Ron Bekkerman, Haifa (IL); Amir Kaldor, Atlit (IL)

(21) Appl. No.: 14/959,166

(22) Filed: Dec. 4, 2015

Related U.S. Application Data
(60) Provisional application No. 62/088,034, filed on Dec. 5, 2014.

(51) Int. Cl. G06N 3/08; G06N 3/04

(52) U.S. Cl. CPC G06N 3/08; G06N 3/0472

(57) ABSTRACT

A method of machine learning for generating a predictive model of a response characteristic based on historical data elements using a processor may include receiving historical data elements and historical values for the response characteristic related to uses of the historical data elements in web pages. A plurality of key-value pairs may be generated defining values of a plurality of predefined features representing properties of the historical data elements. Each of a plurality of n features may be represented by an axis in an n-dimensional space are extracted from the historical data elements. The extracted plurality of key-value pairs for each historical data element may be projected onto the n-dimensional space. The plurality of vectors may be input into a model generator to generate a predictive model predicting a value of the response characteristic for a new data element.

### CROSS REFERENCE TO RELATED APPLICATIONS

This application claims the benefit of prior U.S. Provisional Patent Application No. 62/088,034 filed on Dec. 5, 2014, which is incorporated in its entirety herein by reference.

### FIELD OF EMBODIMENTS OF THE INVENTION

Embodiments of the present invention relate to machine learning. Specifically, some embodiments of the present invention relate to a device, system and method for generating a predictive model from a set of historical data elements by machine learning.

### BACKGROUND OF THE INVENTION

Building predictive models that can predict trends and metrics in new data samples representing a given event or class of events based upon previous or historical data samples is known in the field of machine learning as predictive analytics. An objective of using predictive models may be to assess a likelihood that future data samples representing the same given event or class of events will behave similarly relative to past performance.

### SUMMARY OF EMBODIMENTS OF THE INVENTION

There is thus provided, in accordance with some embodiments of the present invention, a method of machine learning for generating a predictive model of a response characteristic based on historical data elements using a processor, the method includes: receiving historical data elements and historical values for the response characteristic related to uses of the historical data elements in web pages; extracting from the historical data elements, a plurality of key-value pairs defining values of a plurality of predefined features representing properties of the historical data elements, each of a plurality of n features represented by an axis in an n-dimensional space; projecting the extracted plurality of key-value pairs for each historical data element onto the n-dimensional space so as to map the projected plurality of key-values pairs into an n-dimensional vector, wherein each vector represents a plurality of feature values for a single historical data element, and a plurality of vectors represents the feature values for a plurality of historical data elements; and inputting the plurality of vectors into a model generator to generate a predictive model predicting a value of the response characteristic for a new data element.

Furthermore, in accordance with some embodiments of the present invention, when a feature is not represented by an axis, the processor is configured to project the value associated with the feature using an orthogonality relationship between a new axis corresponding to the feature and one or more existing axes of the n-dimensional space.

Furthermore, in accordance with some embodiments of the present invention, the method includes partitioning the plurality of vectors into a training set and a validating set, using the training set to generate the predictive model and the validating set to validate the predictive model by computing an error based on the difference between the historical value of the response characteristic for each of the historical data elements represented by the plurality of vectors in the validating set and a predicted value of the response characteristic for the historical data element generated by the predictive model by inputting each of the plurality of vectors in the validating set into the model generator.

Furthermore, in accordance with some embodiments of the present invention, when the computed error is above a predefined threshold, the method includes receiving a new plurality of historical data elements that are represented by a new plurality of vectors and retraining the predictive model by inputting the new plurality of vectors into the model generator.

Furthermore, in accordance with some embodiments of the present invention, the model generator includes a support vector model (SVM) and predicting the value includes using a set of coefficients output by the SVM to predict the value of the response characteristic for the new data element.

Furthermore, in accordance with some embodiments of the present invention, the model generator includes a neural network model and predicting the value includes using a set of weights output by the neural network model to predict the value of the response characteristic for the new data element.

Furthermore, in accordance with some embodiments of the present invention, the response characteristic is selected from the group consisting of a number of clicks; a number of times that a web page is shared, saved or viewed; and a number of times that a user clicks on a specific button, icon or image on a web page.

There is further provided, in accordance with some embodiments of the present invention, a system of machine learning for generating a predictive model of a response characteristic based on historical data elements, the system including: a memory configured to store historical data elements and historical values for the response characteristic related to uses of the historical data elements in web pages; and a processor configured to extract from the historical data elements, a plurality of key-value pairs defining values of a plurality of predefined features representing properties of the historical data elements, each of a plurality of n features represented by an axis in an n-dimensional space, to project the extracted plurality of key-value pairs for each historical data element onto the n-dimensional space so as to map the projected plurality of key-values pairs into an n-dimensional vector, wherein each vector represents a plurality of feature values for a single historical data element, and a plurality of vectors represents the feature values for a plurality of historical data elements, and to input the plurality of vectors into a model generator to generate a predictive model predicting a value of the response characteristic for a new data element.

### BRIEF DESCRIPTION OF EMBODIMENTS OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1 schematically illustrates a method for generating a predictive model from historical data elements by machine learning, in accordance with some embodiments of the present invention;

FIG. 2 is a flowchart illustrating a method for generating a predictive model by machine learning, in accordance with some embodiments of the present invention;

FIG. 3 is a system for generating a predictive model by machine learning, in accordance with some embodiments of the present invention;

FIG. 4 is a diagram of a neural network, in accordance with some embodiments of the present invention; and

FIG. 5 is a high level block diagram of a computing device for generating a predictive model by machine learning, in accordance with some embodiments of the present invention.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF EMBODIMENTS OF THE INVENTION

In the following description, various aspects of the present invention will be described. For purposes of explanation, specific configurations and details are set forth in order to provide a thorough understanding of the present invention. However, it will also be apparent to one skilled in the art that the present invention may be practiced without the specific details presented herein. Furthermore, well known features may be omitted or simplified in order not to obscure the present invention.

Unless specifically stated otherwise, as apparent from the following discussions, it is appreciated that throughout the specification discussions utilizing terms such as “processing,” “computing,” “calculating,” “determining,” or the like, refer to the action and/or processes of a computer or computing system, or similar electronic computing device, that manipulates and/or transforms data represented as physical, such as electronic, quantities within the computing system's registers and/or memories into other data similarly represented as physical quantities within the computing system's memories, registers or other such information storage, transmission or display devices.

Embodiments of the present invention described herein include devices, systems, and methods for preparing historical data elements for use in designing, training and validating predictive models for machine learning applications, which may use, for example, support vector machines (SVM) and/or neural networks as a model generator. In some embodiments, the historical data elements include textual data that may be used to predict some activity related to a relevant field of science, engineering, or general computing applications based on stored historical data and user responses to the stored historical data. For example, the historical data elements may be associated with historical information or values defining a response characteristic representing the behavior of multiple users in a web-environment, such as, the behavior of users navigating through a series of web pages or web elements (e.g., text blocks, images, icons) within a web page by clicking on a web page or web element. User responses to the web page may be measured, for example, by the response characteristic, such as a number of clicks, that the user executes at a given web page or web site. Any suitable metric may be used to quantify the user response characteristic. The historical data elements may include information, for example, about location, dates, numerical data, multi-media streams and various text strings or semantic values associated with user-behavior. The historical data elements may be obtained from any data source(s), such as newspapers, television, radio, web, historical archives, etc.

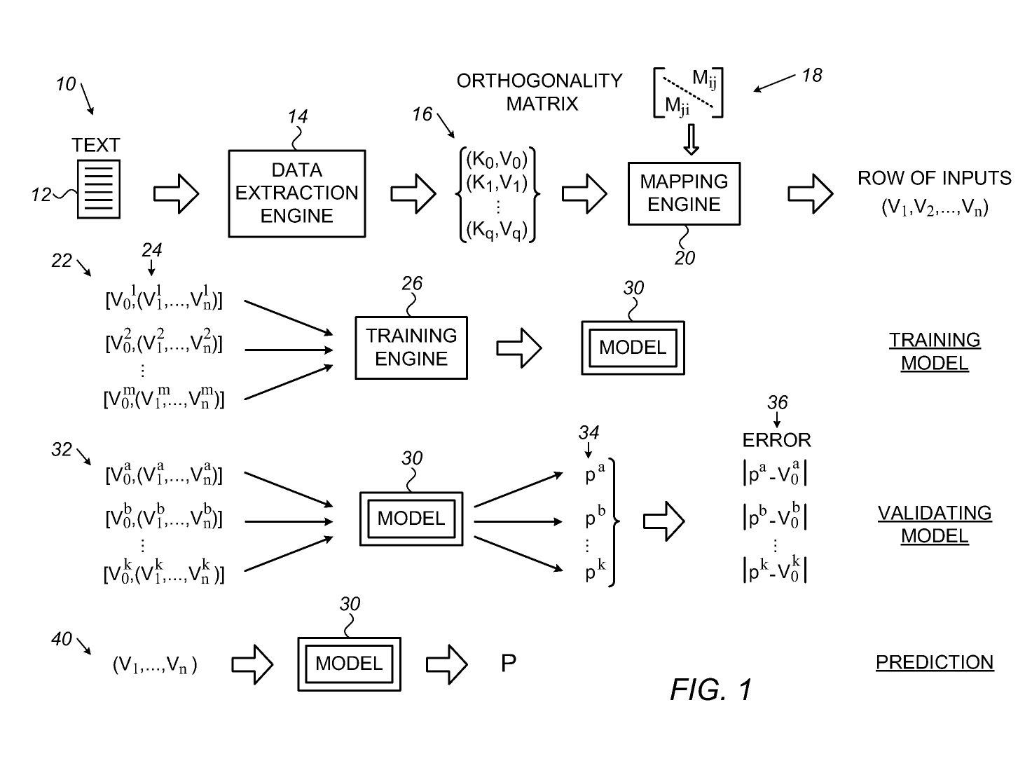

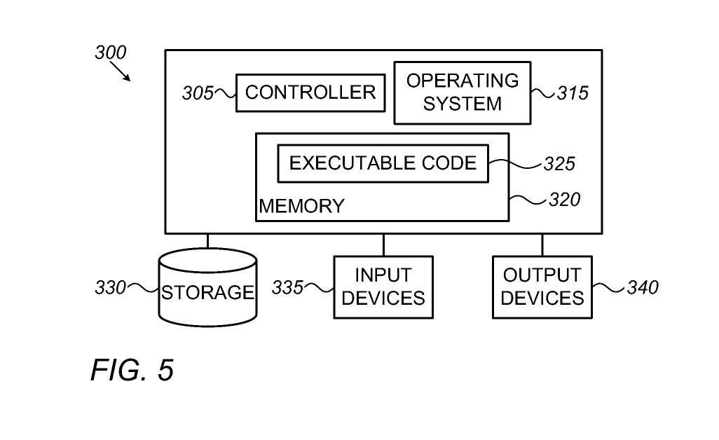

Reference is made to FIG. 1, which schematically illustrates a method for generating a predictive model from historical data elements by machine learning, in accordance with some embodiments of the present invention. A method 10 for mapping a single historical data element 12, which may include text, images or multi-media content, into a vector row of inputs is executed using a processor (e.g., as shown in FIG. 5). The processor receives single historical data element 12 including a single historical value for a response characteristic. In some embodiments, historical data element 12 may include a data element, such as, a web page, a web document, or text, image or content on a web page. The response characteristic may include uses of those data elements, for example, a number of clicks made to a web page; a number of times that a web page is shared, saved, or viewed; a number of times that a user clicks on a specific button, icon or image on a web page; or values derived therefrom.

A single historical data element 12 may be sent along with a single historical value of the response characteristic to be parsed and processed by a data extraction engine 14. Data extraction engine 14 extracts from single historical data element 12, a plurality of q key-value pairs 16 represented by (Kᵢ,Vᵢ) where i=0, 1, . . . q. The extracted key-value pairs 16 may be categorized within predefined classification groups, or categories, or based on the key representing the characteristics of the data to be modeled. For example, (Clicks, 36) and (Location, “Potomac, Md.”). The first element Kᵢ of the key-value pair is known as the key, or feature, and the second element Vᵢ is known as the value, or feature value. For a given feature such as Location, there may be thousands of extracted feature values such as “Potomac, Md.”, “New York, N.Y.”, “Baltimore, Md.”, etc. A first key-value pair (K₀,V₀) may be reserved for the user response characteristic, and may be given along with historical data element 12 to train or validate the model.

Each historical data element and the extracted q key-value pairs (Kᵢ,Vᵢ) may be parsed and/or categorized based on predefined classification groups into features Kᵢ such as the number of clicks, date, location, temperature, height, weight, shoe size, semantic text data, multi-media stream, as well as accompanying feature values Vᵢ. The extracted key-value pairs (Kᵢ,Vᵢ) may subsequently be projected onto n-axes in an n-dimensional space where each of the n feature values is represented by one of the n-axes, where n is an integer.

Each of the q key-value pairs may be mapped to a different axis in n-dimensional space, where the set of axes may represent the features of the data to be modeled. For example, in 4-D space, four features such as temperature, height, weight, and shoe size can have respective coordinate values (e.g., 31.4 centigrade, 188 centimeters, 76.5 kilograms, and 13-wide). When there is no relationship between two features represented on two axes, the axes are orthogonal. At the other extreme, an example of two parameters that are 100% related (and e.g., defined by the same or parallel axes) are height in inches and height in centimeters. By knowing one of these parameters, the other is known with 100% certainty. The axes may be orthogonal to one another (e.g., defining completely independent features), parallel to one another (e.g., defining completely dependent features), or may be neither orthogonal nor parallel to one another (e.g., defining partially inter-related features). The inter-relationship between the axes and features may be defined by an orthogonally relationship (e.g., defined by a difference, distance or angle between the axes, or a weight or projection factor there between).

In some embodiments of the present invention, orthogonality relationships may be represented in an orthogonality matrix m_{i,j}, which may be defined for example as:

$${m}_{i , j} = \frac{1}{1 + D ( {x}_{i} , {x}_{j} )} \qquad ( 1 )$$

Equation (1) defines the relationship between different axes in n-space, where D is a distance function, or distance measure between two axes i^{th} and j^{th}·D(xᵢ,xⱼ)=D² is typically used so as not to return negative values such that

$${m}_{i , j} = \frac{1}{1 + {D}^{2}} \qquad ( 2 )$$

For every orthogonality matrix element m_{i,j}, a number e.g., between 0 and 1 (inclusive), or a multiple thereof, may be stored reflecting the orthogonality relationship between the i^{th} and j^{th} axes, m_{i,j}. The orthogonality relationship and the distance may be inversely related according to equation (1) and/or (2). For example, when the i^{th} and j^{th} axes are fully correlated m_{i,j}=1, the axes are parallel and the distance between the axes D=0, or conversely when the i^{th} and j^{th} axes are fully independent m_{i,j}=0, the axes are orthogonal and the distance between the axes D→∞. The orthogonality matrix may be symmetric. Using a 1/(1+D²) orthogonality relationship to compute projections along the axes in n-space is a non-limiting example of embodiments of the present inventions described herein, and any suitable relationship may be used to determine the relative dependencies, distances, or angle between the axes in the n-space.

In some embodiments, historical data elements 12 may also include images and/or multi-media content in addition to textual data. The presence of images may be a feature defined on one axis in n-space with key-value pairs (images, 0) for no images present, and (images, 1) when images are present, and/or an (actual) number of images may be represented on an orthogonal axis in n-space, e.g., (number_images, 150). In the same manner, multi-media content may be characterized and quantified. In some embodiments, the content of the images may become a mapped feature. For example to represent an image of a terrain, a set of axes among the n-axes may represent the presence of certain features of the terrain, such as a mountain, forest, ocean, sea, lake, urban setting, etc., which can be used to parse the image into key-value pairs (mountain, 1), (forest, 0), etc. and map the features onto respective axes.

In some embodiments, the historical data elements may include actual numerical values, which are used as the feature values directly input into the predictive models. For example, if the number of clicks by users on a link on a particular web page is 12, the key-value pair for the link data element is (“click count”, 12). A person's height may be 188 cm, so the key-value pair for the person's data would be (“height”, 188 cm). In contrast, there may be “non-numerical” data, which is a term defined herein to mean not only text data or images, but also numbers that have no relative meaning on a scale associated with the modeled feature. For example, for a location feature, a postal code for a Manhattan neighborhood in New York, N.Y. may be “10024” and for Potomac, Maryland may be “20854”. Both “20854’ and “10024” are numbers, but have no relative meaning on a numerical scale. For example, a greater zip code number does not signify a relatively closer or farther distance and one number cannot be subtracted from the other to define a distance e.g., from New York, N.Y. to Potomac, Md. So, postal codes are also defined herein as non-numerical data, by way of example.

Some embodiments provide methods for mapping historical data elements and corresponding response characteristic into numerical data samples for use in predictive models. Such methods may include applying a distance measure, orthogonality relationship or projection factor between two values or axes in the data set, for defining the inter-relationship between two non-numerical data of related classification groups. The distance measure as classified by “physical distance”, “temporal distance” and “semantic distance” is described below:

(1) Physical Distance: The actual coordinates of a location are not meaningful in the context of inputs to the predictive model. For example, the textual data “Potomac, Maryland” may be represented by zip code 20854 (a non-numerical representation). To measure relative distances between two locations, directly comparing non-numerical representation of two locations, such as zip codes, has little meaning as previously mentioned.

In some embodiments, a location may be measured relative to a reference point. The location reference point may include the physical location of a user, a location defined in the textual data, or any suitable reference point. A physical distance from the reference point may be used according to a quadratic projection factor of k/(1+D²), where k is a constant or tuning parameter (the equation for k=1 is shown in Eqn. (2)), and distance measure D measures the actual distance in relevant units. So for physical locations, for example, using a location granularity of 25 miles and k=1, locations 50 miles apart may have an orthogonality relationship or projection factor of 1/(1+2²) or ⅕, e.g., 20% using Eqn. (2).

(2) Temporal Distance: A similar approach may be used for relating non-numerical values of time. In some embodiments, a temporal distance factor may be defined with reference to data created in the past with reference to another time, e.g., today. For example, using a temporal granularity of 1 month and assuming that the temporal reference is November, 2015, to project data created November, 2015, (distance unit of 0) the 1/(1+D²) factor is 1. Data created in September, 2015 has 2 (temporal) distance units, or an orthogonality relationship or projection factor of 1/(1+2²)=⅕, e.g., 20%.

(3) Semantic Distance: a similar approach may be used to define semantic distance. Consider that the historical data elements include occupational data such as a C programmer. The orthogonality relationship or projection factor (similarity) between a C++ programmer and a C programmer may be determined empirically to be 98%, while the semantic distance between a C programmer and a nurse may be 0.01%, or even zero since there is little (if any) relationship between the two unrelated textual parameters.

In some embodiments of the present invention, the n-dimensional space may be represented by a data structure or matrix with n-columns representing the n-axes of n-data features. The n-data features, characteristics, or feature values may be more broadly grouped into predefined classification groups such as location, time, temperature, height, weight, and shoe size, for example. Each row, or vector, in the data structure may represent one data sample to be used as an input into the predictive model. Each row may represent the features and associated values associated with one historical data element in a set of m historical data elements where m is an integer. Mapping engine 20 may generate each row vector in n-space by projecting q extracted key-value pairs 16 of one historical data element 12 onto n feature values. Mapping engine 20 may convert any non-numerical data in the key-value pair into meaningful numerical values for one or more features using an orthogonality matrix 18 as shown in FIG. 1 and defined previously in Equations (1) and (2). By mapping one key-value pair 16 onto multiple features using its projection onto additional feature axes, mapping engine 20 may grow one piece of information into many pieces to extrapolate new information where information is otherwise missing. Mapping engine 20 may map different key-value pairs 16, using orthogonality matrix 18, into a row input vector denoted (V₁, V₂, . . . Vₙ) as shown in FIG. 1.

Mapping engine 20 may use any suitable arrangement to map the information in the q extracted key-value pairs to the row input vector (V₁, V₂, . . . Vₙ) using the n-axes. For a set of m historical data elements 12, each of the m historical data elements may be mapped into a row of the m×n matrix in the form (V₁¹, V₂¹, . . . Vₙ¹), (V₁², V₂², . . . Vₙ²), . . . , (V₁^{m}, V₂^{m}, . . . Vₙ^{m}). Again, V₀ may be reserved for the historical value of the response characteristic and does not appear in the row input vectors.

Some embodiments of the present invention may construct a predictive model 30 from a set of m historical data elements 12, where each historical data element in the set includes a historical value for a response characteristic. Suppose that the historical data element 12 is a web page describing a job associated with a particular location and the response characteristic is the number of user clicks on the web page. In the example above, a user wants to predict how many clicks a new web page describing a job associated with the same or different location will receive based on the historical data element 12 (e.g., based on content, posting date, text strings, location, etc.). Method 10 maps the historical data elements 12 into vectors of numerical data samples so as to train the predictive model in a training method 22 using a set of multiple historical data elements 12. Each of the m historical data elements 12 in the set may include a historical value for the (previously measured) response characteristic (V₀) to create a set 24 of input vectors e.g., of the form [V₀¹, (V₁¹, V₂¹, . . . Vₙ¹)], [V₀², (V₁², V₂², . . . Vₙ²)] . . . [V₀^{m}, (V₁^{m}, V₂^{m}, . . . Vₙ^{m})]. Set 24 of input vectors are input into a training engine 26 so as to train predictive model 30. Training engine 26 may include a model generator that uses a support vector machine (SVM), a neural network model, or any suitable model generator that will accurately predict a new value of the response characteristic for a newly received historical data element after training.

A method 10 is provided for mapping the historical data elements 12 into vectors of numerical data samples and training method 22 for creating model 30. In the following example, six historical data elements are input to train the model, which are divided into two classification groups, “Location” and “Population” and a historical training value “clicks”. The data extraction engine first extracts key-value pairs from each of the (e.g., six) historical data elements to generate (e.g., three) key-value pairs (K₀, V₀), (K₁, V₁), (K₂, V₂) for the following three classification groups: clicks, Location, and zip_codes as follows:

{(clicks, 12), (zip_codes, 2), (Location, “Potomac, Md.”)},
{(clicks, 45), (zip_codes, 30), (Location, “Washington, D.C.”)},
{(clicks, 89), (zip_codes, 25), (Location, “Baltimore, Md.”)},
{(clicks, 19), (zip_codes, 9), (Location, “Reston, Va.”)},
{(clicks, 110), (zip_codes, 51), (Location, “Richmond, Va.”)},
{(clicks, 36), (zip_codes, 2), (Location, “Potomac, Md.”)}

This example also illustrates that given m sets of (Kᵢ,Vᵢ) pairs mapped in mapping engine 20 to m input vectors, each vector of order n, one or more of the Kᵢ values may be the same among the m sets of (Kᵢ,Vᵢ) pairs, as for the (Location, “Potomac, Md.”) pairs in the first and sixth key-value pairs in the example above. Generally, this may be prevalent for training set 24, where typically m>>n.

To determine the features in the model, a processor may initially scan the training data set in a pre-training stage to determine all the independent features. For example, the training data includes zip codes so a feature n=1 of population size may be defined as the number of zip codes assigned to the geographical area. In addition, the training data includes five locations (Potomac Md., Washington D.C., Baltimore Md., Reston Va., and Richmond Va.). Each location is a potentially distinct feature (defining the relative distance to that reference location). Typically, the pre-scan phase may generate a total number of features, for example, on the order of n=10,000-50,000. Note that each feature K in the above (K,V) pairs represents one of the axes, or columns in the matrix. For this example, the features are “number of zip_codes”, and one or more of the locations “Potomac, Md.”, “Washington, D.C.,” “Baltimore, Md.,” “Reston, Va.” and “Richmond, Va.”. The first feature K₀ may be the number of clicks, which is the response characteristic.

To define the non-numerical values for the Location features, the processor may first construct orthogonality matrix 18. Consider a distance matrix in which Potomac, Md. is the reference location (Table I, row 1 below). The reference location means the comparative location from which a relative location metric is measured. If the reference location changes, a new orthogonal row may be computed. A distance matrix may be constructed to define the distance from Potomac, Md. (column 1), Washington D.C. (column 2), Richmond, Va. (column 3):

TABLE I
Distance Matrix for Location Features
Distances
Distance Unit 10 miles

| | Poto- | Washing- | Rich- | Balti- | Res- |
|---|---|---|---|---|---|
| | mac, MD | ton, DC | mond, VA | more, MD | ton, VA |
| Poto- | 0 | 15 | 90 | 45 | 18 |
| mac, MD | | | | | |
| Washing- | 15 | 0 | 80 | 31 | 9 |
| ton, DC | | | | | |
| Rich- | 90 | 90 | 0 | 106 | 78 |
| mond, VA | | | | | |

In this example, there may be new features that are not in the historical data set, such as “Baltimore, Md.” (column 4) and “Reston, Va.” (column 5). These features may be added to the orthogonality matrix dynamically during a prediction operation that includes a new location. Assuming a distance unit of 10 miles, applying equation (2), orthogonality matrix 18 may be given by:

TABLE II
Orthogonality matrix for Table I
Distances Orthogonality Matrix

| | Poto- | Washing- | Rich- | Balti- | Res- |
|---|---|---|---|---|---|
| | mac, MD | ton, DC | mond, VA | more, MD | ton, VA |
| Poto- | 1 | 0.3077 | 0.0122 | 0.0471 | 0.2358 |
| mac, MD | | | | | |
| Washing- | 0.3077 | 1 | 0.01538 | 0.0943 | 0.5525 |
| ton, DC | | | | | |
| Rich- | 0.0122 | 0.0122 | 1 | 0.0088 | 0.0162 |
| mond, VA | | | | | |

Consider the key-value pairs related to the first training record (e.g., first historical data element) that are applied to mapping engine 20: (Clicks, 12) and (Location, “Potomac, Md.”). The processor may generate a row, or row vector, related to the first historical training data element as:

TABLE III
Training vector {(clicks, 12), (zip_codes,
2), (Location, “Potomac, MD”)}:

| | Vector elements | | | | |
|---|---|---|---|---|---|
| | 0 | 1 | 2 | 3 | 4 |
| Input row | 12 | 2 | 1.0000 | 0.3077 | 0.0122 |

In this case, the number of features n=4 axes are defined by Column 1=population factor, or the number of zip codes in the given geographic area; Column 2=Relative Location: Potomac, Md. to Potomac, Md.; Column 3=Relative Location: Potomac, Md. to Washington, D.C.; Column 4=Relative Location: Potomac, Md. to Richmond, Va. Column 0 is for the response characteristic=no. of clicks (not part of the n=4 vector). Hence, the elements of the n=4 vector along with the response characteristic V₀¹=12, or the number of clicks (e.g., the value of the response characteristic). V₁¹=2 which is the population factor in the area of Potomac, Md., since it has two zip codes. The derived orthogonality matrix may be used to determine the location value V₂¹=1 (Potomac, Md. relative to Potomac, Md. as in column 2 in Table III). V₃¹=0.3077 (Potomac, Md. relative to Washington, D.C. as in column 3 in Table III) and V₄¹=0.0122 (Potomac, Md. relative to Richmond, Va. as in column 4 in Table III), and so forth for the rest of the input vectors.

TABLE IV
Training vector {(clicks, 89), (zip_codes, 25),
(Location, “Baltimore, MD”)}:

| | Vector elements | | | | |
|---|---|---|---|---|---|
| | 0 | 1 | 2 | 3 | 4 |
| Input row | 89 | 25 | 0.0471 | 0.0943 | 0.0088 |

In this case, Baltimore, Md. is the reference location, clicks=89 and there are 25 zip codes, but there is no predefined feature value for Baltimore, Md. Column 2 (Potomac) the distance from Baltimore to Potomac=45 miles. Using distance units of 10 miles granularity, orthogonality matrix element in column 2 is 1/(1+(45/10)²)=0.0471. Similarly, for column 3 (Washington, D.C.), the distance from Baltimore to Washington is 31 miles. The orthogonality matrix element in column 3 is 1/(1+(31/10)²)=0.0943. For column 4 (Richmond, Va.), the distance from Baltimore to Richmond is 106 miles. The orthogonality matrix element in column 4 is 1/(1+(106/10)²)=0.0088. The same methodology applies to Reston, Va. Accordingly, when a feature (e.g., such as Baltimore, Md. and Reston, Va. in the location classification group as in this example) does not have an associated dimension in the n-dimensional space, projecting a value associated with the feature using an orthogonality relationship (e.g., Eqn. (2)) between a new axis corresponding to the missing feature and one or more existing axes of the n-dimensional space.

Table V shows a plurality of the input rows, or the plurality of vectors of numerical data samples in this example excerpt where each vector represents a plurality of feature values (e.g., columns 1-4) for a single historical data element as well as the historical value of the response characteristic (e.g., the number of clicks in column 0) used for generating training model 30 (e.g., training set 24) in method 22 as shown in FIG. 1.

TABLE V
Excerpt of Input Vectors for Training the Predictive Model

| | Clicks | Zipcodes | Potomac | Washington | Richmond |
|---|---|---|---|---|---|
| | Vector elements | | | | |
| | 0 | 1 | 2 | 3 | 4 |
| Input row | 12 | 2 | 1.0000 | 0.3077 | 0.0122 |
| | 45 | 30 | 0.3077 | 1.0000 | 0.0154 |
| | 89 | 25 | 0.0471 | 0.0943 | 0.0088 |
| | 19 | 9 | 0.2358 | 0.5525 | 0.0162 |
| | 110 | 51 | 0.0122 | 0.0154 | 1.0000 |
| | 36 | 2 | 1.0000 | 0.3077 | 0.0122 |

To generate the predictive model, the above excerpt (n=4) shown in Table V may be incorporated into a complete input matrix on the order of n˜10,000-50,000 which may be input into an SVM model generator. For the above n=4 input vectors, the model generator may output a vector of four coefficients (c₁, c₂, c₃, c₄)=(2, 15, −30, −9), which can be used to predict a value of the number of clicks for a new data element. The dot product of this vector with coefficients, namely (c₁, c₂, c₃, c₄)·(V₁¹, V₂¹, V₃¹, V₄¹)=V₀¹, yields the predicted response characteristic. This equation may be similarly applied to the other input vectors, e.g., (c₁, c₂, c₃, c₄)·(V₁², V₂², V₃², V₄²)=V₀², and so forth. Note that a full vector of coefficients for a complete input matrix for e.g., n=50,000 would be of the form (c₁, c₂, c₃, . . . , c_{50,000}).

The 4-dimensional excerpt used above is shown merely for conceptual clarity, and not by way of limitation of the embodiments of the present invention. The method and system described herein for generating predictive models are trained with sets including thousands or millions of historical data elements that are mapped to multiple classification groups and subsequent features (n) within the groups (i.e., n-axes), such that n is typically on the order of 10,000-50,000, or larger. There may be e.g., 10,000 location features alone in the “Location” classification group, such that the methods described herein may only be performed using a computer.

The method and system according to embodiments of the invention are specific to a computer (web) environment. The historical data elements and associated user response characteristics, which are used to generate the predictive model, are metrics of how users navigate through a web environment, for example, defined by response characteristics such as user clicks, related to uses of the historical data elements in web pages. In some embodiments these metrics may be used to automatically rearrange new data elements on the web page data or navigate a user to an appropriate web page or web content based on its associated metrics.

In some embodiments of the present invention, a set of historical data elements may be partitioned into a training set and a validating set where the training set is used in training 22 method for generating model 30. The validity set is used for validating 32 model 30 after training.

After a given time period that model 30 is used, the model may need to be validated. A method 32 for validating the model is shown in FIG. 1. In this case, a validating set of k historical data elements are processed by mapping engine 20 and the k vectors (V₁^{k}, . . . Vₙ^{k}) along with the measured value of the response characteristic (e.g., V₀^{k}) are input into model 30. Model 30 may be used to generate predicted values 34 denoted (p^{a}, p^{b}, . . . , p^{k}). Model 30 may then compute a set of errors 36 e.g. (|p^{a}−V₀^{a}|, |p^{b}−V₀^{b}, . . . |p^{k}−V₀^{k}|) based on the difference between the historical values of the response characteristic (V₀^{a}, V₀^{b}, . . . V₀^{k}) for each historical data element represented by the plurality of vectors in the validating set and a predicted value of the response characteristic (p^{a}, p^{b}, . . . p^{k}) generated by the predictive model 30 by inputting each of the plurality of vectors in the validating set into the model generator. If these computed errors are assessed to be above some predefined threshold, then model 30 may be retrained.

In some embodiments of the present invention, the computed error may include a root mean square (RMS) sum of differences of |p^{a}−V₀^{a}|, |p^{b}−V₀^{b}|, . . . |p^{k}−V₀^{k}|. Any suitable error may be computed in validation method 32. Retraining model 30 includes receiving a new (or partially new) training set of historical data elements which are used to repeat training method 22 as shown in FIG. 1, inputting different constants, metrics, thresholds, or other model parameters.

In some embodiments, validating method 32 includes computing error 36 for one or more different models, each using a different model generator (e.g., SVM, neural networks, etc.) in training model 30, and dynamically switching between models by selecting the model that exhibits the lowest computed error.

In some embodiments of the present invention, prediction method 40 includes applying model 30 to a input vector (V₁, . . . Vₙ) derived from a received historical data element via mapping method 10 so as to predict a new predicted value P of the response characteristic.

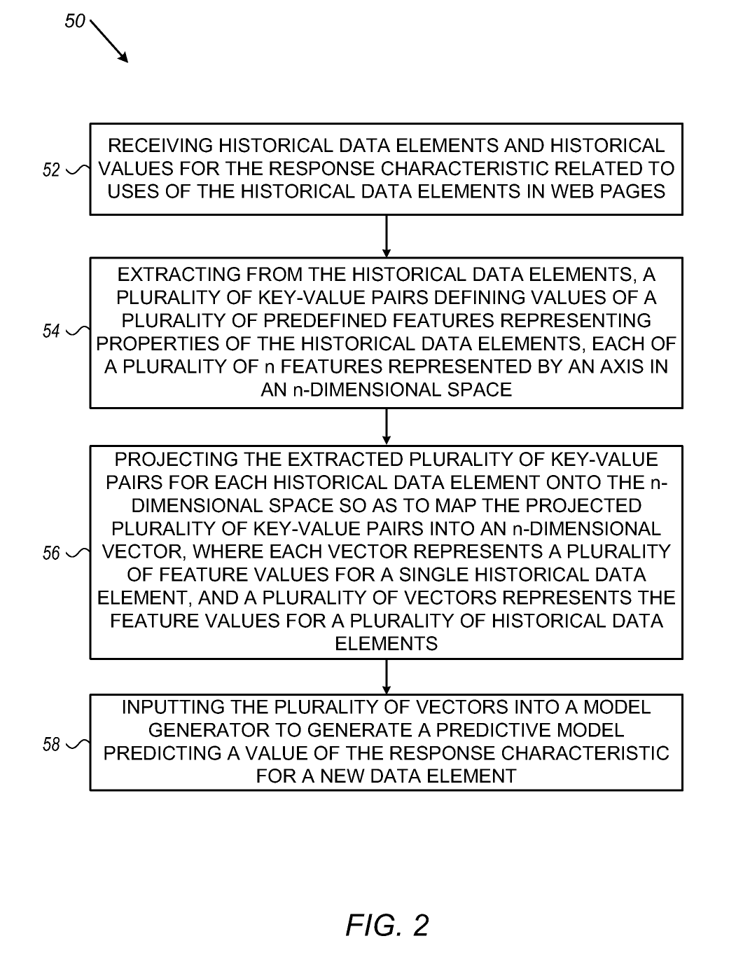

FIG. 2 is a flowchart illustrating a method 50 for generating predictive model 30 by machine learning, in accordance with some embodiments of the present invention. Method 50 includes receiving 52 historical data elements 12 and historical values for the response characteristic (e.g., V₀) related to uses of historical data elements in web pages. Method 50 includes extracting 54 from historical data elements 12, a plurality of key-value pairs defining values of a plurality of predefined features representing properties of the historical data elements, each of a plurality of n features represented by an axis in an n-dimensional space. Method 50 includes projecting 56 the extracted plurality of key-value pairs for each historical data element onto the n-dimensional space so as to map the projected plurality of key-values pairs into an n-dimensional vector, where each vector represents a plurality of feature values for a single historical data element, and a plurality of vectors represents the feature values for a plurality of historical data elements. Finally, method 50 includes inputting 58 the plurality of vectors into a model generator to generate a predictive model predicting a value of the response characteristic for a new data element.

Embodiments of the invention for modelling and predicting metrics may be applied to modeling user behavior to improve many technological fields, such as for example web navigation optimizing how users operate and navigate through websites, as well as other behavior including web searching for job postings, vehicle traffic patterns, shopping behavior, crime patterns, etc.

An example illustrating some of the embodiments of the present invention described herein includes a device, system and method for autonomously or automatically predicting one or more response characteristics such as clicks of data elements that are online job postings. A “job posting” may refer to any description or advertisement of a contract, part-time, or permanent employment position, for example, posted by a company or individual. The job posting may include features such as job title, responsibilities, industry, salary, benefits, location, and/or preferred qualifications. An employment website displaying the job postings may allow applicants to respond to the job posting, for example, by clicking on the post e.g. to obtain more information, sharing, saving or watching/the post, or submitting or uploading application materials to the website for review by the job poster.

Job postings or advertisements may be submitted or uploaded online or via the web. When used herein, the “web” may refer to the World Wide Web, which may include the Internet and/or an Intranet. The web may be used interchangeably with the Internet and/or Intranet, as the web is a system of interlinked hypertext documents and programs accessed via the Internet and/or Intranet. Job postings may be uploaded or submitted to message boards or social media websites such as Twitter, Facebook, or Craigslist, for example, or to websites that include a classifieds section such as the websites for the New York Times, Washington Post, Los Angeles Times, or to websites that specialize in career advancement or connections, such as Monster, LinkedIn, Indeed, CareerBuilder, or to other kinds of websites. In some embodiments, training data from additional sources such as newspapers, television, radio, archives, etc. may also be used.

Some embodiments of the present invention may use historical data of user interactions with job postings to build a model that predicts how future job postings may perform on different websites or different kinds of websites or how job candidates may respond to the future job postings. Different employment or job posting websites may have different cost structures for companies who wish to upload a job posting (e.g., a flat fee to post a job description, pay-per-click for each job selection, extra costs to feature a job prominently on a website, or a combination thereof). By predicting the response of job viewers to job postings, the model may be used by a job poster to determine an optimal budget or strategy based on the amount of exposure desired in recruiting job applicants.

In the example of job postings, the prediction process may include: generating a predictive model that is optimized or configured to predict desired features of posted jobs; receiving a job description (e.g., a newly received historical data element) to be posted online; applying the model to predict the selected features if the job was to be posted; and retraining the model based on the volatility of the data periodically or after a period of time, such as a week or a month. Predictive models and algorithms may include support vector machines (SVM), for example, systems for running linear regressions on historical data and extrapolating or predicting trends from the historical data to estimate future behavior; neural networks, or other algorithms.

In some embodiments of the present invention modeling a plurality of job posting performance metrics, response characteristics may include, for example:
(1) Click count: a number of times a job posting is selected or viewed.
(2) Apply count: a number of times an “apply for job” button is selected.
(3) Application count: a number of times an applicant completes the application process for a job.
(4) Time of day posting is clicked.
(5) Elapsed time required to complete a job application.

Any other suitable response characteristic or performance metrics may be used.

In some embodiments of the present invention, historical data element 12 for a job posting may be mapped into the following features and/or classification groups:
(1) Location: e.g., city, state, and/or country of the job.
(2) Job title: e.g., generated based on extracted words from the job description, which may use free text or context-sensitive analysis to find exact matches as well as synonyms (e.g., fuzzy search).
(3) Job Category: grouping of similar jobs, based on job title and job description. e.g., jobs for C++ programmers may be similar to jobs for C# programmers or Java programmers and may be grouped under the same general Job Category of ‘Programmers’.
(4) Seasonality: a factor that may reflect the seasonality of the job posting (e.g., service jobs may peak in December while teaching positions may peak in the spring in preparation for the next academic year).
(5) Environmental: one or more factors that may affect the performance of the job posting on a given web site (e.g., amount of web traffic on the site, specificity of the site relative to job posting such as site specializing in ‘nurse’ positions, demographics of region served by the website, input/output devices supported by the website, such as, a mobile enabled site, etc.).
(6) Other factors that may be used to quantify and distinguish the performance of a job posting across multiple websites.

Some embodiments of the invention may also provide a unified or structured taxonomy for representing job data, which is generally non-uniform and non-structured. For example, whereas conventional methods may miss correlations between similar job postings because their job titles are written in a different way, a vector feature that incorporates metrics in Job Categories by Location may allow prediction even when the actual phrasing of the job title may be different.

A useful technique for handling free text (such as job title or job description) may be to use a taxonomy coupled with context-sensitive analysis to map the nearly infinite free text possibilities into a well-defined set. This reduces the prediction analysis from operating on nearly infinite categories of metrics into a bounded, finite, discrete set of metrics which are then suitable for prediction.

For each feature (in categories such as location, job title, category, seasonality, environmental, and/or complements and combinations), the predictive model may input historical data (e.g., historical number of clicks) collected for that classification over a predetermined period of time (e.g., 12 months or other suitable period of time when seasonality is a factor) into the support vector machine, neural network or any linear regression model.

The vectors may be used to train the model with historical correlations between job classifications and performance metrics (“training phase”, e.g., training 22 method in FIG. 1). The predictive model may be used to predict future performance metrics for a new job posting (e.g., predicted number of clicks), before the job posting is ever posted. The processor may then compare the predicted future metrics (e.g., p^{a}, p^{b}, . . . p^{k} in FIG. 1) with actual metrics such as the actual number of clicks (e.g., V₀^{a}, V₀^{b}, . . . V₀^{k} in FIG. 1) collected during a second (e.g., more recent) predetermined period of time (e.g., the previous full month) to verify the accuracy of the model (“verification phase”, e.g., verification 32 method in FIG. 1). The accuracy of the model and its predictions may be measured, for example, as an error reflecting how closely the predicted value matches or dovetails the actual value. One such measurement is the root mean square (RMS) error equation between the historical performance metric and the actual performance metric:

$$RMS = \sqrt{\frac{1}{n} ( {x}_{1}^{2} + {x}_{2}^{2} + … + {x}_{n}^{2}} \qquad ( 3 )$$

where x₁, x₂ . . . xₙ are the differences or errors between each predicted click pⁱ and actual click V₀ⁱ (e.g., xᵢ²=(pⁱ−V₀ⁱ)₂). The computed RMS error is shown in Table VI using Eqn. (3) is an example of computed aggregate, or total error; however, the error for predicting the accuracy of the model may be computed by any suitable error computation.

TABLE VI
Computation of RMS errors

| Job | Fea- | Fea- | . . . Fea- | Predicted | Actual | Prediction |
|---|---|---|---|---|---|---|
| ID | ture 1 | ture 2 | ture n | clicks | clicks | Error |
| 1 | Value_{1, 1} | V_{1, 2} | V_{1, n} | 100 | 90 | 10 |
| 2 | Value_{2, 1} | V_{2, 2} | V_{2, n} | 85 | 93 | −8 |
| RMS | | | | | | 9.06 |

The processor may compare the prediction error to a specified or predefined threshold to determine if the model is sufficiently accurate. For example, if the error is below the threshold, the model may be accepted as sufficiently accurate, while if the error is above the threshold, the model may be retrained until it achieves a below-threshold error. Furthermore, the training and verification phases may be further repeated or iterated to refine the model by including additional features or deleting features in the model in order to find the optimal mix of features which yield a good prediction error, e.g., a prediction error that is less than a threshold.

In some embodiments of the present invention, predictive model 30 may iteratively and/or periodically repeat the above training and validation phases over time (e.g., weekly, monthly, etc.) to adapt to changing new data. For example, the predictive model may build a model for next month by training the model with this month's data.

The types of model generators (e.g., training engine 26 in FIG. 1) used in model 30 are given in the summary below:

A. Support Vector Machines (SVM) (e.g., supervised learning, autonomous prediction)
SVM algorithms typically include the following steps:
Step 1: Encode each historical data element or job post in the ‘training’ set of data whose features are normalized features into input vectors for an SVM.
Step 2: Supervised training phase: An implementation of Support Vector Machines (e.g. “SVM_light”) may then be used to derive an SVM (regression) predictive model from the input vectors.
Step 3: Validation phase: Input the predictive model derived from the training set and run each historical data element or job post from the validating set individually through the SVM predictive model. The output of the validation phase are the prediction values for the specified features.
Step 4: The predicted values are compared to the actual values. Various measures of the quality or error of the prediction include: RMSE (Root Mean Square Error), MAE (Mean Absolute Error), StdDev (Standard Deviation), etc. If these error values are outside of an expected range, steps [1-4] may be rerun with internal tuning parameters adjusted or new training data.
Step 5: ‘Prediction’ phase or method 40 (production) may then predict features of any new data element or job post by running the data element's features through the predictive model to generate a prediction.
Step 6: Repeat steps 1-4 periodically, for example, on a reasonable frequency, based on data volatility in order to refresh the SVM predictive model. For example, this may be done once per month.
   B. Neural Networks algorithms may include the following steps:
Step 1: Training phase: The algorithm builds a neural net using training data 24. Back propagation using the ‘validation’ values is used to train the neural net.
Step 2: Validation phase or method 32: the predicted results (p^{a}, . . . , p^{k}) are compared to the actual values (V₀^{a}, V₀^{b}, . . . , V₀^{k}) (since we are working with historical data). Various measures of the quality of the prediction include: RMSE, MAE, StdDev, and others. If these error values are outside of an expected range (e.g., the expected error), step 1 can be rerun with the internal tuning parameters adjusted or new training data.
Step 3: Prediction phase (e.g., prediction method 40): predict features on any new data element or job post. Steps 1 and 2 are repeated periodically, for example, on a reasonable frequency, based on data volatility in order to refresh the neural model. For example, this may be done once per month.
   C. Custom algorithms include the following iteration of steps:
Step 1: Build an internal model 30 using training set 22.
Step 2: Fine tune model 30 using validating set 32.
Step 3: Measure prediction quality (e.g., errors 30−RMSE, MAE, StdDev).
Repeat above steps with appropriate tuning or new training data when quality measures are assessed to exceed the expected range (e.g., a predefined threshold).
Step 4: Use the Model to predict Feature values for new data.
Step 5: Retrain the model periodically as needed (based on data volatility).

According to some embodiments of the invention, the SVM and neural network models, generate linear predictive models, to generate predicted values or metrics by relatively fast machine learning computations, which improves the computational efficiency and speed of the computer. For example, the model is trained using the SVM and an optimized set of linear coefficients is generated, after training the model with e.g., hundreds of thousands of training vectors from the plurality of historical data samples. The generated set of coefficients is used in the dot product (a linear operation) with the mapped vector corresponding to the new data element to linearly predict the response characteristic. Similarly, a neural network based model creates an optimized set of weights from the plurality of training vectors which are linearly applied to the mapped vector corresponding to the new data element to predict the response characteristic. A linear prediction function, such as those used in SVM and neural networks, use a relatively fast and computationally efficient process, wherein the computation time grows linearly as the complexity and size of model increases. The optimized method of computation of the predicted value of the response characteristic using both SVM and neural networks significantly improves the computational speed and efficiency of the computer.

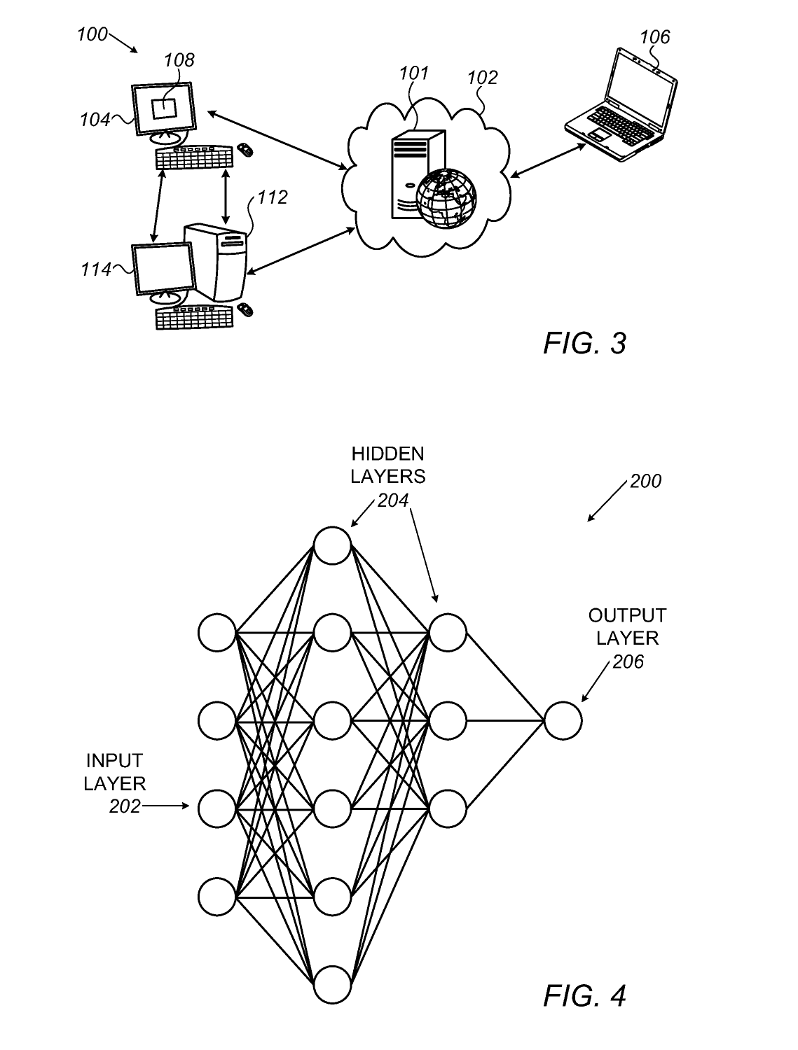

FIG. 3 is a system for generating a predictive model by machine learning, in accordance with some embodiments of the present invention. Websites, such as social media websites or job-posting websites 101, may be hosted on the Internet 102 and accessible by a company 104 and a user device 106 e.g., operated by a job applicant. Examples of computing devices include a laptop, desktop, smart phone, tablet or other computing device able to access the web. Typically, company 104 may post a data element 108 e.g., job description on a computing device 104, which may be sent to one or more of the websites 101. Prior to posting data element 108, company 104 may use software or a third-party service to build a model predicting the response or performance of the data element 108. The software may be stored and executed on the computing device of company 104, or the software may be stored and executed on a third party server 112 or computer 114.

To build a model, a server 112 (or for example, memory stored in computer 114) may receive and store historical data elements 108 e.g., on job description posted within a predetermined or selected period of time, e.g. the last 12 months, two years, etc. The historical data element 108 may include a set of job postings or descriptions and each of their response characteristics historically recorded from user devices 106. Response characteristics to data elements 108 such as a job posting may include performance metrics such as a number of clicks or views of the posting, a number of times the posting is shared, saved or watched, a number of applications submitted, or a number of times a user clicks on an “apply” button or completes the job application process.

Embodiments of the invention may incorporate a taxonomy to classify raw information associated with the data element 108 (and similarly for titles and any other free text and non-textual information) into standardized categories which allows the prediction algorithm, along with historical data, to build a predictive model which may then be used to predict the desired performance features for new data elements. The historical data elements may be partitioned into groupings or sets including: a first set (e.g., the training set) for training data to create the model, and a second set (e.g., the validating set) to validate the created model and calculate error between the predicted model results and actual results. For example, a first set may include a random subset (e.g., 90%) of the historical data elements. Other percentages may be used, such as 75% or 82%. The historical data elements in the first set may be “randomized” or distributed over time in that the first set includes a portion of historical data elements randomly (or non-randomly, e.g., periodically) distributed along the entire historical set (e.g., instead of using a solid block of time such as the first 11 months or first 8 months as training data). The randomization may help to maintain the seasonality of the training set. The second set may include the remaining data elements in the historical set in order to validate the created model.

Each data element in the historical set may be classified into features. In the example of job postings, the job postings may be classified, for example, by job title, location, category, industry, required experience, or other parameters. A taxonomy engine may use textual and context-sensitive analysis methods to classify the historical data elements or determine other parameters. Since the same type of features (e.g. job titles, categories, and industries) may be described in different ways in different historical data elements, the taxonomy engine may group similar titles, categories, and industries into a discrete classification. Each historical data element may further include data on one or more response characteristics that is being modeled, e.g. a number of clicks or views of the historical data element. Historical data elements may be simplified or encoded to be represented in a table or database and stored in memory (e.g., memory 330 and/or 320 in FIG. 5), where each historical data element may be identified by an ID, and classified by various parameters, key-value pairs and features.

In some embodiments of the present invention, using SVM, the selection of a set of features could allow each discrete feature (e.g., job location, discrete job title, and discrete job category, as established by use of a Taxonomy) to be used as an independent axis or dimension among the n-axes in the feature vector space. The projection of a historical data element or its feature values onto these axes (during the training phase) may be non-zero for each dimension associated with a selected or known feature and zero for each dimension associated with a non-selected feature. The projection onto these axes may be the data element's actual metrics, for example number of clicks or other characteristic with a value of 0 or 1.0 (such as ‘not popular’ or ‘popular’). It is also possible for a metric to project onto a plurality of non-orthogonal axes (similar to an n-dimensional vector projecting on the Cartesian axis which can serve as the basis). Other axes (e.g., features represented as each element in each job vector) may include, for example, the month (or day) of the year when expecting seasonal data or additional metrics associated with the location (such as demographics, proximity to other regions, etc.). A separate projection vector may be constructed for each historical data element in the training set, expressing the projection of its metrics (e.g., clicks) onto the axes or dimensions of the feature vector space. These vectors may be used as the input into an SVM (e.g., SVM Lite). The SVM then generates a model, which may be used to generate a prediction for other new data elements (not in the training set). Other features may be used for the features set (axes) such as average clicks for data elements with same location and category but not the same title.

As an illustrative example, a series of vector features V₀ⁱ,(V₁ⁱ . . . , Vₙⁱ) may be generated that represent the ‘n’ modeled features of a historical data set from the training data for each data element vector Vⁱ. The first vector feature V₀ⁱ may represent the value of the first feature for the data element classification that is being modeled (e.g., average number of clicks for all jobs with the same job title and location as a future job posting). The other vectors (V₁ⁱ . . . , Vₙⁱ) may represent the features of the historical data set being modeled for other classifications or combinations or complements of classifications of the i^{th} data element. For example, vectors (V₁ⁱ . . . , Vₙⁱ) include one or more features, such as: an average number of clicks for all jobs with the same job title, an average number of clicks for all jobs within the same industry, the average number of clicks for all jobs with the same location, an average number of clicks for all jobs with the same category and location, an average number of clicks for all jobs with the same job title and a complement of a location (e.g., jobs located outside of New York City). Other vectors using different classifications or combinations of classifications may be used. Historical data may be selected, split or partitioned according to prediction needs. For example, for seasonal jobs, the historical data may be partitioned by only including jobs with the same job expiration month or seasonality factor (e.g., month of the year).

FIG. 4 is a diagram of neural network 200, in accordance with some embodiments of the present invention. In another embodiment, a neural network may be used to build predictive model 30. A set of features or feature vectors may be selected in a similar manner as described above using the SVM model (e.g., using a combination of classifications and compliments of classifications). In neural networks, the projection of data of a data element (e.g., a job posting) onto the feature axis would be a 0 if the axis does not apply to the data element, and a 1 if it does (or some number between 0 and 1 reflecting the overlap between the axes). For example, a job posting for location of ‘New York City’ would project a 1 on the ‘New York City’ axis, and 0 on any other location axis (however, if there was a location axis of ‘Brooklyn, New York’, then the value might be 0.8 to reflect the proximity of Brooklyn to New York City (Manhattan)). Similarly for the job title, job category, and other text-based data, a taxonomy engine may be used to determine whether these characteristics apply to each feature axis or not (e.g., projecting a value of 1 or 0), or whether the projection value should be somewhere in between. For axes describing features having a numerical value (for example, a job's location population rank among all locations) the actual value associated with the job posting should be used instead of a 1 or 0 value. This set of vectors may then be used to train a neural net composed of an Input layer 202, one or more Hidden layers 204, and an Output layer 206.

Each metric of data elements may form the input layer 202, and the output layer 206 may include a single node representing the predicted value, such as clicks for that data element. Each input node may be a metric of a data element. For example, there may be a separate (distinct) input node for each of the data element features (there may several thousand of these), for each of the job categories (several hundreds), for each of the locations (again, possibly thousands), and for other metrics. For each data element, most of the input values may be zero, except where the data element's data matches the input node description. The initial Hidden layer 204 is connected to the Input layer via a set of ‘weights’ that propagate the Input layer 202 values to the Hidden layers 204. If the model is composed of multiple Hidden layers, then each Hidden layer may be connected via weights to the successive Hidden layer. The last Hidden layer may then be connected via weights to the Output layer. The neural network algorithm may use any of several techniques (e.g., supervised back-propagation learning) to establish or determine the optimal weights such that the error threshold (comparing predicted clicks versus actual clicks) goal is achieved. Methods as known in the art for optimizing weights may be used.

FIG. 5 is a high level block diagram of a computing device 300 for generating a predictive model by machine learning, in accordance with some embodiments of the present invention. Computing device 300 may include a controller 305 that may be, for example, a central processing unit processor (CPU), a chip or any suitable computing or computational device, an operating system 315, a memory 320, a storage 330, an input devices 335 and an output devices 340. Computing device 300 may be any one of the computing devices described in FIG. 1, e.g. computing devices 104, 114, 106 or servers 101 or 112.

Operating system 315 may be or may include any code segment designed and/or configured to perform tasks involving coordination, scheduling, arbitration, supervising, controlling or otherwise managing operation of computing device 300, for example, scheduling execution of programs. Operating system 315 may be a commercial operating system. Memory 320 may be or may include, for example, a Random Access Memory (RAM), a read only memory (ROM), a Dynamic RAM (DRAM), a Synchronous DRAM (SD-RAM), a double data rate (DDR) memory chip, such as DDR3 or DDR4, memristors, optical chips, quantum memories, any non-volatile or volatile memory using any current or future memory chip technology, a Flash memory, a cache memory, a buffer, a short term memory unit, a long term memory unit, or other suitable memory units or storage units. Memory 320 may be or may include a plurality of, possibly different memory units.

Executable code 325 may be any executable code, e.g., an application, a program, a process, task or script. Executable code 325 may be executed by controller 305 possibly under control of operating system 315. Executable code 325 may perform steps to predict response characteristics to a job posting such as receiving, by a processor, a data set of historical data elements such as job postings, wherein each data element includes at least one response characteristic; determining classification parameters for each of the historical data elements; receiving a potential new data element; generating a model, based on the data set of historical data elements; and predicting a response characteristic for the potential new data element based on the generated model. For example, executable code 325 may be an application that performs methods as described herein. In some embodiments, more than one computing device 300 may be used. For example, a plurality of computing devices that include components similar to those included in computing device 300 may be connected to a network and used as a system. Controller or processor 305 may, for example, be configured to carry out all or part of the present invention by for example executing software or code such as code 325.

Storage 330 may be or may include, for example, a hard disk drive, a universal serial bus (USB) device, a Digital Video Disc (DVD) drive, cloud/internet based storage, or other suitable removable and/or fixed storage unit. Data may be stored in storage 330 and may be loaded from storage 330 into memory 320 where it may be processed by controller 305.

In some embodiments, some of the components shown in FIG. 5 below may be omitted. For example, memory 320 may be a non-volatile memory having the storage capacity of storage 330. Accordingly, although shown as a separate component, storage 330 may be embedded or included in memory 320.

Input devices 335 may be or may include a mouse, a keyboard, a touch screen or pad or any suitable input device. It will be recognized that any suitable number of input devices may be operatively connected to computing device 300 as shown by block 335. Output devices 340 may include one or more displays, speakers and/or any other suitable output devices. It will be recognized that any suitable number of output devices may be operatively connected to computing device 300 as shown by block 340. Any applicable input/output (I/O) devices may be connected to computing device 300 as shown by blocks 335 and 340. For example, a wired or wireless network interface card (NIC), a modem, printer or facsimile machine, a universal serial bus (USB) device or external hard drive may be included in input devices 335 and/or output devices 340.

Embodiments of the invention may include an article such as a computer or processor non-transitory readable medium, or a computer or processor non-transitory storage medium, such as for example a memory, a disk drive, or a USB flash memory, encoding, including or storing instructions, e.g., computer-executable instructions, which, when executed by a processor or controller, carry out methods disclosed herein. For example, a storage medium such as memory 320, computer-executable instructions such as executable code 325 and a controller such as controller 305.

Some embodiments may be provided in a computer program product that may include a non-transitory machine-readable medium, stored thereon instructions, which may be used to program a computer, or other programmable devices, to perform methods as disclosed herein. Embodiments of the invention may include an article such as a computer or processor non-transitory readable medium, or a computer or processor non-transitory storage medium, such as for example a memory, a disk drive, or a USB flash memory, encoding, including or storing instructions, e.g., computer-executable instructions, which when executed by a processor or controller, carry out methods disclosed herein. The storage medium may include, but is not limited to, any type of disk including floppy disks, optical disks, compact disk read-only memories (CD-ROMs), rewritable compact disk (CD-RWs), and magneto-optical disks, semiconductor devices such as read-only memories (ROMs), random access memories (RAMs), such as a dynamic RAM (DRAM), erasable programmable read-only memories (EPROMs), flash memories, electrically erasable programmable read-only memories (EEPROMs), magnetic or optical cards, or any type of media suitable for storing electronic instructions, including programmable storage devices.

A system according to embodiments of the invention may include components such as, but not limited to, a plurality of central processing units (CPU) or any other suitable multi-purpose or specific processors or controllers, a plurality of input units, a plurality of output units, a plurality of memory units, and a plurality of storage units. A system may additionally include other suitable hardware components and/or software components. In some embodiments, a system may include or may be, for example, a personal computer, a desktop computer, a mobile computer, a laptop computer, a notebook computer, a terminal, a workstation, a server computer, a Personal Digital Assistant (PDA) device, a tablet computer, a network device, or any other suitable computing device. Unless explicitly stated, the method embodiments described herein are not constrained to a particular order or sequence. Additionally, some of the described method embodiments or elements thereof can occur or be performed at the same point in time.

Some embodiments of the present invention described herein model the behavior of multiple users interacting with data elements such as job posting on a web page by generating the predictive model, which predicts a value of the user response characteristic such as the number of clicks on the data elements. In some embodiments, the predicted value, such as the predicted number of clicks, can be used by the company managing the posting of the job ad for a potential employer to give a price offer based on the cost per click, for example. The company managing the job posting may guarantee to the potential employer that the job posting will garner a certain number of clicks.

In some embodiments of the present invention, the predicted value, such as the predicted number of clicks, can be used as a relative measure as to how much exposure a data element such as a job posting on a web page will receive relative to other data elements in the same category in the market. If the click prediction is below the market average, then a package upgrade to increase the market exposure to a job posting is presented to the potential employer to advertise the job posting on more advertising websites resulting in a package with higher cost per click (CPC).

In some embodiments of the present invention, the predicted value of the response characteristic such as the number of clicks can be used as a metric for understanding how to reformulate, or reword, the job posting to increase the likelihood of clicks. A low click prediction, for example, may be a gauge of low quality wording in the job posting and reformulating content such as rewording text and adding more images to the job posting, for example, may increase the predicted number of clicks.

In some embodiments of the present invention, the predicted value of the response characteristic, such as the predicted number of clicks, can be used to reallocating resources for maintaining the webpage content with multiple job postings in real time. Using the predicted value for the number of clicks on a webpage and monitoring the number of clicks in real time allows the potential employer (e.g., the user) to dynamically invest more in underperforming job posts and less in job posts that are ahead of prediction.

In some embodiments of the present invention, using the predicted value for the number of clicks, for example, for each job posting for a user with multiple job listings, enables a dashboard to be formulated and presented to the user with real time analytics on the total mix of their job postings. The real time analytics may include total budget, the current budget for each job, the real time performance relative to prediction for each job, and suggestions for rebalancing and improving job posting with underperforming features.

Unless explicitly stated, the method embodiments described herein are not constrained to a particular order or sequence. Additionally, some of the described method embodiments or elements thereof can occur or be performed at the same point in time.

Different embodiments are disclosed herein. Features of certain embodiments may be combined with features of other embodiments; thus certain embodiments may be combinations of features of multiple embodiments. The foregoing description of the embodiments of the invention has been presented for the purposes of illustration and description. It is not intended to be exhaustive or to limit the invention to the precise form disclosed. It should be appreciated by persons skilled in the art that many modifications, variations, substitutions, changes, and equivalents are possible in light of the above teaching. It is, therefore, to be understood that the appended claims are intended to cover all such modifications and changes as fall within the true spirit of the invention.

While certain features of the invention have been illustrated and described herein, many modifications, substitutions, changes, and equivalents will now occur to those of ordinary skill in the art. It is, therefore, to be understood that the appended claims are intended to cover all such modifications and changes as fall within the true spirit of the invention.

1. A method of machine learning for generating a predictive model of a response characteristic based on historical data elements, the method comprising:
using a processor:
receiving historical data elements and historical values for the response characteristic related to uses of the historical data elements in web pages;
extracting from the historical data elements, a plurality of key-value pairs defining values of a plurality of predefined features representing properties of the historical data elements, each of a plurality of n features represented by an axis in an n-dimensional space;
projecting the extracted plurality of key-value pairs for each historical data element onto the n-dimensional space so as to map the projected plurality of key-values pairs into an n-dimensional vector, wherein each vector represents a plurality of feature values for a single historical data element, and a plurality of vectors represents the feature values for a plurality of historical data elements; and
inputting the plurality of vectors into a model generator to generate a predictive model predicting a value of the response characteristic for a new data element.

2. The method according to claim 1, wherein when a feature is not represented by an axis, the processor is configured to project the value associated with the feature using an orthogonality relationship between a new axis corresponding to the feature and one or more existing axes of the n-dimensional space.

3. The method according to claim 1, further comprising partitioning the plurality of vectors into a training set and a validating set, using the training set to generate the predictive model and the validating set to validate the predictive model by computing an error based on the difference between the historical value of the response characteristic for each of the historical data elements represented by the plurality of vectors in the validating set and a predicted value of the response characteristic for the historical data element generated by the predictive model by inputting each of the plurality of vectors in the validating set into the model generator.

4. The method according to claim 3, further comprising, when the computed error is above a predefined threshold, receiving a new plurality of historical data elements that are represented by a new plurality of vectors and retraining the predictive model by inputting the new plurality of vectors into the model generator.

5. The method according to claim 1, wherein the model generator comprises a support vector model (SVM) and wherein predicting values comprises using a set of coefficients output by the SVM to predict the value of the response characteristic for the new data element.

6. The method according to claim 1, wherein the model generator comprises a neural network model and wherein predicting values comprises using a set of weights output by the neural network model to predict the value of the response characteristic for the new data element.

7. The method according to claim 1, wherein the historical data elements comprise historical job postings and the new data element comprises a new job posting.

8. The method according to claim 1, wherein the response characteristic is selected from the group consisting of a number of clicks; a number of times that a web page is shared, saved or viewed; and a number of times that a user clicks on a specific button, icon or image on a web page.

9. A system of machine learning for generating a predictive model of a response characteristic based on historical data elements, the system comprising:
a memory configured to store historical data elements and historical values for the response characteristic related to uses of the historical data elements in web pages; and
a processor configured to extract from the historical data elements, a plurality of key-value pairs defining values of a plurality of predefined features representing properties of the historical data elements, each of a plurality of n features represented by an axis in an n-dimensional space, to project the extracted plurality of key-value pairs for each historical data element onto the n-dimensional space so as to map the projected plurality of key-values pairs into an n-dimensional vector, wherein each vector represents a plurality of feature values for a single historical data element, and a plurality of vectors represents the feature values for a plurality of historical data elements, and to input the plurality of vectors into a model generator to generate a predictive model predicting a value of the response characteristic for a new data element.

10. The system according to claim 9, wherein when a feature is not represented by an axis, the processor is configured to project the value associated with the feature using an orthogonality relationship between a new axis corresponding to the feature and one or more existing axes of the n-dimensional space.

11. The system according to claim 9, wherein the processor is configured to partition the plurality of vectors into a training set and a validating set, and to use the training set to generate the predictive model and the validating set to validate the predictive model by computing an error based on the difference between the historical value of the response characteristic for each of the historical data elements represented by the plurality of vectors in the validating set and a predicted value of the response characteristic for the historical data element generated by the predictive model by inputting each of the plurality of vectors in the validating set into the model generator.

12. The system according to claim 11, wherein when the computed error is above a predefined threshold, the processor is configured to receive a new plurality of historical data elements that are represented by a new plurality of vectors and retrain the predictive model by inputting the new plurality of vectors into the model generator.

13. The system according to claim 9, wherein the model generator comprises a support vector model (SVM), and wherein the processor is configured to predict values by using a set of coefficients output by the SVM to predict the value of the response characteristic for the new data element.

14. The system according to claim 9, wherein the model generator comprises a neural network model and wherein the processor is configured to predict values by using a set of weights output by the neural network model to predict the value of the response characteristic for the new data element.

15. The system according to claim 9, wherein the historical data elements comprise historical job postings and the new data element comprises a new job posting.

16. The system according to claim 9, wherein the response characteristic is selected from the group consisting of a number of clicks; a number of times that a web page is shared, saved or viewed; and a number of times that a user clicks on a specific button, icon or image on a web page.
